(19) United States
(12) Patent Application Publication
(10) Pub. No.: US 2009/0238170 A1
(43) Pub. Date: Sep. 24, 2009

(54) METHOD AND SYSTEM FOR PROVIDING VOICE OVER IP (VOIP) TO WIRELESS MOBILE COMMUNICATION DEVICES

(76) Inventors: Muralidhar RAJAN, Bangalore (IN); Santosh Prabhu, Bangalore (IN); Sachin D. Naik, Bangalore (IN)

Correspondence Address: KYOCERA WIRELESS CORP., P.O. BOX 928289, SAN DIEGO, CA, 92192-8289, US

(21) Appl. No.: 12/051,743

(22) Filed: Mar. 19, 2008

(51) Int. Cl. H04L 12/66; H04B 7/00

(52) U.S. Cl. 370/352; 455/41.2

(57) ABSTRACT

A wireless voice over Internet Protocol (VOIP) system comprises a VOIP-enabled wireless communication device (WCD) and a VOIP gateway. The WCD includes a short-range wireless interface and a client application configured to place and receive VOIP calls through the short-range wireless interface. The VOIP gateway includes a short-range wireless interface for communicating with the WCD, a network interface for communicating with the Internet, and a VOIP service client configured to communicate with a VOIP service over the Internet by way of the network interface. The VOIP gateway also includes a proxy server configured to act as an interface between the WCD client application and the VOIP service client and to route the VOIP calls through the gateway's short-range wireless interface.

### TECHNICAL FIELD

The present invention generally relates to voice over Internet Protocol (VOIP) services, and more particularly, to wireless VOIP systems.

### BACKGROUND

VOIP systems allow telephone calls to be placed over TCP/IP networks, such as the Internet. The advantage of VOIP telephony is that VOIP phone calls are often substantially less expensive than calls placed using conventional telephone services.

Unlike conventional telephone calls, which are typically placed from a telephone through a telephone network, VOIP calls are typically placed from a computer through the Internet. VOIP telephone handsets have been developed that closely resemble conventional telephones in appearance. However, instead of connecting to a conventional telephone network, these VOIP telephones connect to computers, such as personal computers (PCs), that are in turn connected to the Internet. Vonage and Skype are two examples of commercially-available VOIP services that allow users with computers or VOIP telephones to make voice telephone calls over the Internet.

VOIP telephony is currently available on some wireless phones and headsets. Implementing VOIP solutions on a wireless phone gives the user mobility, but adds additional processing overhead that can strain the limited computing resources of the wireless phone. For example, some currently available VOIP wireless phones require the phone to have a TCP/IP network protocol stack, thereby increasing the processing requirements and cost of the wireless phone. In addition, placing VOIP calls over conventional cellular carrier networks is generally not cost efficient from a user's perspective.

In a non-mobile setting, where VOIP telephony is present on a computer such as a laptop/desktop PC, the computer typically has sufficient processing capability and network connectivity to adequately support VOIP telephony, but suffers from a lack of mobility. A wireless headset operating with a VOIP-enabled computer can provide the user with limited mobility, but cannot provide the flexibility and functionality that a cellular phone or personal digital assistant (PDA) can provide.

Thus, there is a need for an improved VOIP system that offers VOIP services to wireless communication devices, e.g., cellular phones and PDAs, with the processing power, lower cost and network connectivity typically associated with VOIP-enabled computers.

### SUMMARY

Disclosed herein is an improved VOIP system that includes a VOIP software application in a client-server format, where the client resides on a wireless communication device (WCD) and the server resides on a computer such as laptop or desktop PC. The server provides much of the VOIP capabilities and thereby carries out most of the processing. The client, on the other hand, has relatively limited functionality, e.g., interpreting user actions and informing the server to take certain actions. This allows the client to be executed on devices such as cellular phones and PDAs without overly taxing their computing resources, and thereby provides VOIP users with greater wireless mobility, flexibility and functionality.

In accordance with an exemplary embodiment, a wireless VOIP system comprises a VOIP-enabled WCD and a VOIP gateway. The WCD includes a short-range wireless interface and a client application configured to place and receive VOIP calls through the short-range wireless interface. The VOIP gateway includes a short-range wireless interface for communicating with the WCD, a network interface for communicating with the Internet, and a VOIP service client configured to communicate with a VOIP service over the Internet by way of the network interface. The VOIP gateway also includes a proxy server configured to act as an interface between the WCD client application and the VOIP service client and to route the VOIP calls through the gateway's short-range wireless interface.

Other embodiments, aspects, features, advantages of the invention will be or will become apparent to one with skill in the art upon examination of the following figures and detailed description. It is intended that all such additional aspects, features, and advantages be included within this description and be protected by the accompanying claims.

### BRIEF DESCRIPTION OF THE DRAWINGS

It is to be understood that the drawings are solely for purpose of illustration and do not define the limits of the invention. Furthermore, the components in the figures are not necessarily to scale. In the figures, like reference numerals designate corresponding parts throughout the different views.

FIG. 1 illustrates an exemplary wireless communications system for providing VOIP services to wireless users.

FIG. 2 is a block diagram illustrating certain components of the wireless communication device and gateway shown in FIG. 1.

FIG. 3 is a flowchart illustrating a method of providing VOIP to the wireless communication device of FIG. 1

FIG. 4 is a flowchart illustrating a method of handing off a cellular call to the VOIP service.

### DETAILED DESCRIPTION

The following detailed description, which references to and incorporates the drawings, describes and illustrates one or more specific embodiments of the invention. These embodiments, offered not to limit but only to exemplify and teach the invention, are shown and described in sufficient detail to enable those skilled in the art to practice the invention. Thus, where appropriate to avoid obscuring the invention, the description may omit certain information known to those of skill in the art.

Additionally, the word “exemplary” is used exclusively herein to mean “serving as an example, instance or illustration” and any embodiment described herein as being “exemplary” is not necessarily to be construed as being preferred or advantageous over any other embodiment.

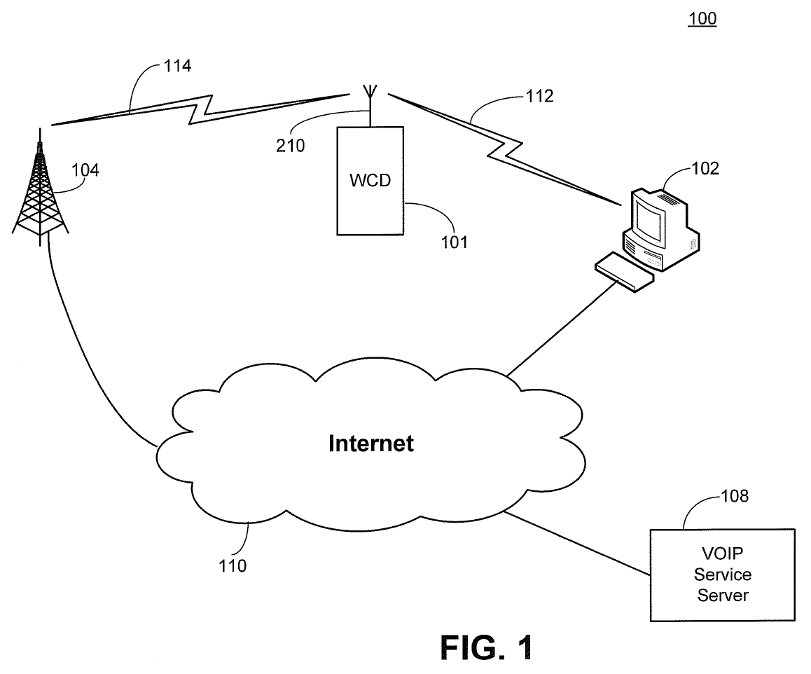

FIG. 1 illustrates an exemplary wireless communications system that provides VOIP services to wireless communication device (WCD) users. The wireless communication system 100 includes one or more WCDs 101 configured to communicate with a wide-area wireless network (WWAN) 104 over a WWAN link 114 and to communicate with a VOIP gateway 102 over a short-range wireless communication link 112. The VOIP gateway 102 and the WWAN 104 are capable of communicating with a VOIP service server 108 by way of the Internet 110.

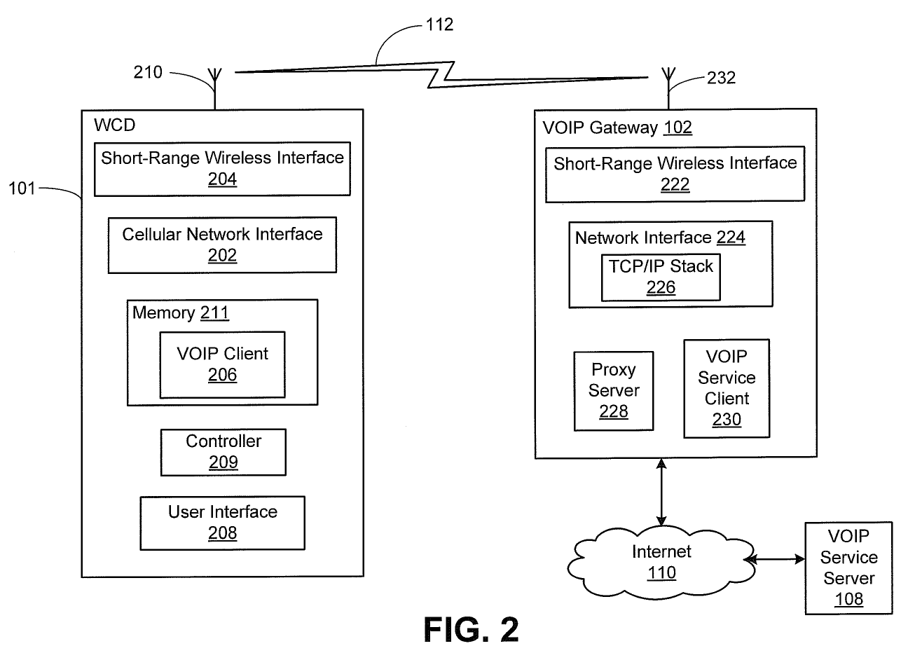

When placing a voice call from the WCD 101, a user can select to place the call through either the VOIP gateway 102 using a VOIP service or through the WWAN network using a cellular service. A VOIP client-server application, having a VOIP client 206 (see FIG. 2) running on the WCD 101 and a VOIP proxy server 228 (see FIG. 2) running on the VOIP gateway 102 allows the WCD 101 to access the VOIP services provided by the VOIP service server 108. The VOIP client-server application can be implemented using the Java programming language, which provides a high degree of portability across different types of devices and servers. The client and server software programs communicate with and configure, respectively, the host on which they are installed through existing or specifically-coded Java routines. The client 206 and proxy server 208 can communicate with one another using the short-range wireless link 112. The short-range wireless link 112 can be established using any suitable wireless technology, such as Wi-Fi (e.g., IEEE-802.11a/b/g/n) or Bluetooth.

The WCD 101 may be any suitable type of wireless communication device, such as a handheld cellular phone, personal digital assistant (PDA), cordless phone, gaming device, or the like, that is configurable to function as described herein and capable of communicating with at least the VOIP gateway 102 over the short-range wireless link 112, and preferably capable of communicating with both the VOIP gateway 102 and WWAN 104 over the respective wireless links 112, 114.

The WWAN 104 is preferably a cellular network such as a CDMA, WCDMA, GSM, UTMS, AMPS, PHS network or the like. The WWAN 104 includes infrastructure comprising those network elements necessary to support wireless voice and/or data communications with the WCD 101. The wireless communication infrastructure includes equipment such as controllers, transceivers and backhaul that establishes and maintains wireless communication with the WCD 101, as well as other terminal devices. The types and numbers of devices within the wireless infrastructures depend on the particular wireless network. For example, a typical cellular network includes sector antennas connected to several base transceiver stations (BTSs) connected to base station controllers (BSCs) that are connected to a mobile switching center(s) (MSC). Cellular base station controllers are typically capable of communicating with an IP-based network, such as the Internet 110, via a packet data server node (PDSN). Base stations are also capable of communicating with the public switched telephone network (PSTN) via the MSC. Thus, conventional cellular base stations included in the WWAN 104 use the MSC and PSTN to provide conventional voice connections and telephony services between the WCD 101 and other telephone devices, such as conventional landline phones. In addition, base stations of the WWAN 104 use a PDSN and the Internet to provide packet data services, such as short messaging service (SMS), between the WCD 101 and Internet protocol (IP) nodes, such as the VOIP service server 108, communicating with the WWAN 104.

The VOIP gateway 102 includes a networked computer configured to act as a gateway to the VOIP service provided by the VOIP service server 108. The VOIP gateway 102 may include any suitable type of computer, such as a laptop or desktop PC having a network interface 224 (see FIG. 2), such as a network interface card, and an operating system, such as Windows®, Linux or the like, that permits data packet communications over the Internet 110 using conventional protocols such as TCP/IP, UDP/IP and/or HTTP. The VOIP gateway 102 also includes a short-range wireless interface 222 (see FIG. 2), such as a commercially-available Wi-Fi or Bluetooth card, for wirelessly communicating with the WCD 101. Further details of the VOIP gateway 102 are described herein below in connection with FIG. 2.

The VOIP service server 108 can include one or more servers running VOIP server application(s) for providing VOIP service to Internet users. The VOIP service can be a commercially-available service, such as those available from Vonage or Skype. The servers themselves may include any suitable type of computer, such as a commercially-available server having a network interface card (not shown) and an operating system, such as Windows®, Linux or the like, that permits data packet communications using conventional protocols such as TCP/IP, UDP/IP and/or HTTP, and a VOIP service application running thereon.

FIG. 2 is a conceptual block diagram illustrating certain components of the WCD 101 and VOIP gateway 102 shown in FIG. 1.

The WCD 101 includes a wide-area cellular network interface 202, one or more antennas 210, a short-range wireless interface 204, a controller 209, a memory 211 storing the VOIP client 206, and a user interface 208 configured to select either the short-range wireless interface 204 or the wide-area cellular network interface 202 to place and receive calls. The WCD 101 can include separate antennas for communicating over the short-range wireless link 112 and WWAN link 114, or alternatively, a single antenna may be used for both links 112, 114.

The cellular network interface 202 comprises the entire physical interface necessary to communicate with the WWAN 104, including a wireless transceiver configured to exchange wireless signals with the WWAN 104. The WWAN interface 202 exchanges wireless signals with the WWAN 104 to facilitate voice calls and data transfers over the WWAN 104 to a connected device. The connected device may be another WWAN terminal, a landline telephone, or network service entity such as a voice mail server, Internet server or the like.

The short-range wireless interfaces 204, 222 comprise the entire physical interface and communication protocols necessary to wirelessly communicate with one another, including wireless transceivers configured to exchange wireless signals between the WCD 101 and VOIP gateway 102. The wireless link 112 between the WCD 101 and VOIP gateway 102 can be any suitable wireless technology, such as such as Wi-Fi (e.g., IEEE-802.11a/b/g/n) or Bluetooth. The VOIP gateway's short-range wireless interface 222 can be a commercially-available Wi-Fi or Bluetooth card. Where the short-range wireless link 112 is Wi-Fi, the short-range wireless interfaces 204, 222 can be configured to support VOIP and to use ad hoc, peer-to-peer connectivity.

The controller 209 manipulates operations of the other components 202, 204, 211, 208 of the WCD 101 and digitized information to ensure that the WCD 101 provides desired voice and data functions to the terminal user, as well as supports the VOIP functionality disclosed herein. Although the controller 209 can be implemented using any suitable combination of hardware and software components, the controller 209 preferably comprises a processor-based architecture that includes a processor (not shown) and the memory 211 for storing software and data. Machine-readable data and executable instructions (also referred to as an application, software, code or program) are stored in the memory 211 and executed (or run) on processor. All memory devices described herein may comprise any suitable combination of volatile (e.g., random access memory) or non-volatile (e.g., read-only memory) storage as known in the art. The processor may comprise a microprocessor, microcontroller, digital signal processor, co-processor, similar devices or combinations thereof. Using known programming techniques, software stored in the memory 211 causes the controller 209 to operate the WCD 101 to achieve the functionality described herein.

The memory 211 stores at least an operating system (OS) (not shown) and the VOIP client application 206. The OS can be an off-the-shelf wireless device OS.

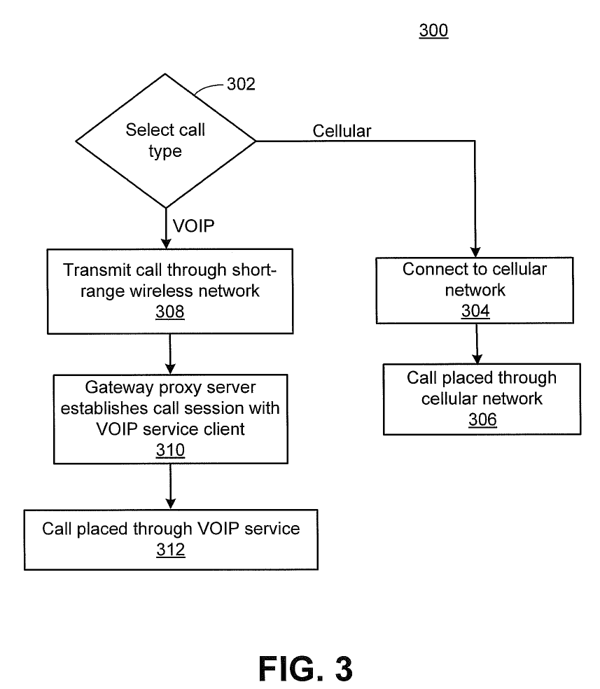

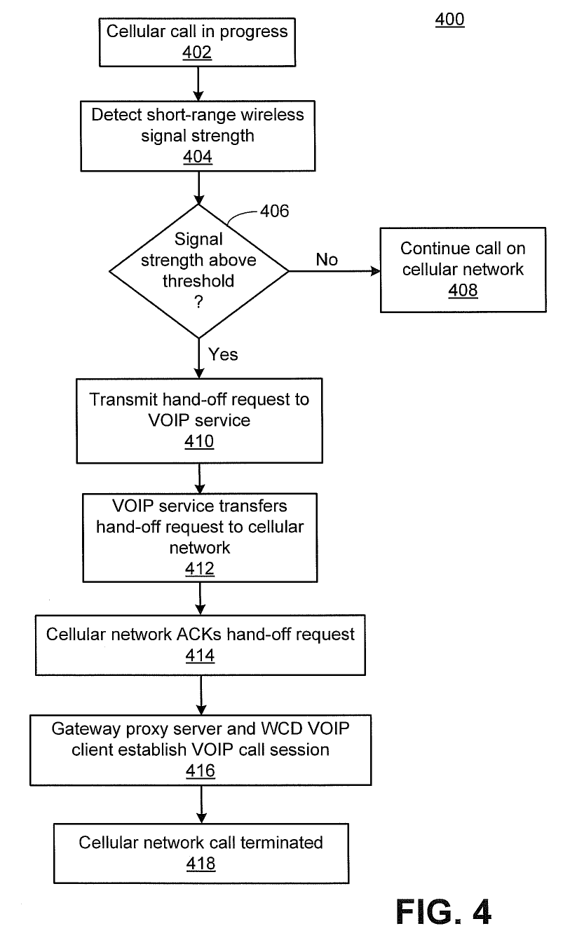

The VOIP client application 206 is a software program running on the OS that causes the WCD 101 to perform the WCD functions described herein and to operate in accordance with the methods described below in connection with FIGS. 3-4. The VOIP client application 206 can be written in Java using conventional software development techniques. The VOIP client 206 executes on the WCD 101 to place and receive VOIP calls through the short-range wireless interface 204. The VOIP client 206 communicates with the VOIP proxy server 228 running on the VOIP gateway 102 over the short-range wireless link 112. In addition, the VOIP client 206 configures the WCD 101 to present on the user interface 208 a selection interface that allows a user to select the type of call to be placed prior to entering the called party's phone number, whether it be a VOIP call or a cellular call. If the VOIP calling feature is selected, the VOIP client 206 collects the called party number and transfers it to the VOIP proxy server 228 over the short-range wireless link 112. The VOIP proxy server 228 then uses the called party number to place the VOIP call through the VOIP service client 230.

The cellular network interface 202, short-range wireless interface 204, controller 209 and memory 11 can be implemented using an off-the-shelf mobile station modem (MSM) chipset.

The user interface 208 provides a means for a user to receive and enter audio, data, commands and the like during use of the WCD 101. The user interface 208 may include any suitable combination of one or more buttons, display screens, touch screens, microphones, speakers, switches and the like, such as those commonly found on conventional wireless handheld devices. The user interface 208 is controlled and monitored by the controller 209.

The VOIP gateway 102 includes an antenna 232, a short-range wireless interface 222, a network interface 222, a VOIP proxy server 228 and a VOIP service client 230. The short-range wireless interface 222 is configured to communicate with the short-range wireless interface 204 of the WCD 101, using the antenna 232.

The network interface 224 is configured to communicate with the Internet 110. The network interface 226 may include a commercially-available network interface card for data packet communications over the Internet 110 using conventional protocols such as TCP/IP, UDP/IP and/or HTTP. The network interface 224 also includes TCP/IP stack 226 for communicating over the Internet 110.

The VOIP service client 230 is configured to communicate with a VOIP service server 108 by way of the network interface 224. The VOIP proxy server 228 is configured to route VOIP calls through the short-range wireless interface 222 and act as an interface between the VOIP client 206 on the WCD 101 and the VOIP service client 230.

The proxy server 228 passes the VOIP calls to and from a VOIP service client 230 residing on the VOIP gateway 102.

FIG. 3 is a flowchart 300 illustrating a method of providing VOIP to the WCD 101 of FIG. 1. With the WCD 101 configured by the VOIP client 206, the user can initiate a call from the WCD 101, which triggers the VOIP client 206 into action. In decision step 302, the user has an option on the WCD 101 to choose between the cellular carrier provided service (CDMA, GSM or the like) through the WWAN 102 and the VOIP service through the VOIP gateway 102. This selection is made available to the user by the VOIP client 206 via the user interface 208.

If the user selects to place the call using the cellular service, the WCD 101 is connected to the WWAN 104 through the WWAN link 114 (step 304) and the call proceeds through the WWAN 104 (step 306).

If the user selects to place the call using the VOIP service, the VOIP client 206 collects all necessary information regarding the call, such as the called party number and the like, and issues a command to the VOIP proxy server 228 through the short-range wireless link 112 in a predefined format recognized by both the VOIP proxy server 228 and VOIP client 206 (step 308).

Once the user chooses the VOIP option for making a call, everything else remains transparent to him/her as if the entire process were carried out in the WCD 101 itself. The VOIP client 206 configures the WCD 101, through standard Java routines, to route all audio to and from the called device through the short-range wireless interface 204 and over the short-range wireless link 112. Audio sent over the short-range wireless link 112 is configured to a format specific to the short-range wireless link 112.

In step 310, the VOIP server 228, upon receiving the command from the VOIP client 206, consisting of the called party number, triggers the VOIP service client application 230 to place the call through the VOIP service server 108 (step 312). The VOIP proxy server 228 also configures the VOIP gateway 102 to route all audio received from the VOIP service client 230 towards the WCD 101 over the short-range wireless link 112, and also configures the VOIP gateway 102 to route all audio received from the WCD 101 over the short-range wireless link 112 to the VOIP service client 230.

Whenever the VOIP call ends, which could be terminated by either the WCD 101 or the called party, the VOIP client 206 and the VOIP proxy server 228 exchange suitable commands and terminate the connection over the short-range wireless link 112. This can also be followed by actions on part of the VOIP client 206 and VOIP proxy server 230 whereby they re-configure their respective hosts (the WCD 101 and VOIP gateway 102, respectively) to their pre-call states.

FIG. 4 is a flowchart 400 illustrates an optional method of handing off an in-progress cellular call at the WCD 101 to the VOIP service. In step 402, the WCD 101 is presently engaged in a call over the WWAN 104. The VOIP client 206, running in background, configures the WCD 101 to monitor the signal strength of the short-range wireless signal emitted by the VOIP gateway 102. This can be done, for example where the short-range wireless link 112 is part of a Wi-Fi network, by monitoring the beacon signal emitted from the gateway's short-range wireless interface 222.

In decision step 406, the VOIP client 206 checks to determine whether the short-range wireless signal strength is above a predefined threshold. If the signal is too weak, the call continues using the WWAN 104 (step 408).

However, if the short-range wireless signal has sufficient strength, a hand-off request message can be transmitted by the VOIP client 206 to the VOIP proxy server 228 by way of the short-range wireless link 112. The hand-off request message can include all of the information (e.g., called party's number and the like) required to set up a VOIP call from the WCD 101. The hand-off request message can also include information necessary to terminate the cellular call on the WWAN 104. The VOIP proxy server 228 passes the message on to the VOIP service server 108 through the VOIP service client 230 (step 410).

In response to the hand-off message, the VOIP service server 108 transfers the hand-off request to the WWAN 104 through the Internet 110 (step 412). The VOIP service server 108 also establishes a VOIP call with the called party. In step 414, the WWAN 104 acknowledges (ACKs) the hand-off request (step 414) and proceeds to terminate the cellular call on the WWAN 104 (step 418). The VOIP service server 108 then sends a message to the VOIP proxy server 228 and VOIP client 206 causing the establishment of a VOIP call between the WCD 101 and the called party by way of the short-range wireless link 112.

The preceding detailed description has illustrated the principles of the invention using a specific communication system and certain methods. However, the invention is not limited to these particular implementations. For example, the inventive principles disclosed herein can be implemented in many other types of wireless networks and with other types of terminal devices.

In addition, the functions and operations of the elements described in FIGS. 1 and 2 may be implemented in any number of devices, circuits, or network elements. Two or more of the functional elements may be integrated into a single device and/or the functions described as being performed in any single device may be implemented over several devices.

Other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined only with reference to the appended claims along with their full scope of equivalents.

What is claimed is:

1. A system, comprising:
a wireless communication device having a short-range wireless interface and a client configured to place and receive voice over Internet Protocol (VOIP) calls through the short-range wireless interface; and
a gateway including a short-range wireless interface configured to communicate with the wireless communication device, a network interface configured to communicated with the Internet, a VOIP service client configured to communicate with a VOIP service by way of the network interface, and a proxy server configured to route the VOIP calls through the short-range wireless interface of the gateway and act as an interface between the client on the wireless communication device and the VOIP service client.

2. The system of claim 1, wherein the wireless communication device further comprises a wide-area cellular network interface.

3. The system of claim 2, wherein the wireless communication device further comprises a user interface for selecting either the short-range wireless interface or the wide-area cellular network interface to place and receive calls.

4. The system of claim 1, wherein the wireless communication device includes a user interface configured to receive a called party number from a user and the client on the wireless communication device is configured to transfer the called party number to the proxy server.

5. The system of claim 1, further comprising an Internet Protocol (IP) stack resident on the gateway.

6. The system of claim 1, wherein the wireless communication device is configured to detect a short-range wireless signal strength and to transmit a hand-off message to the VOIP service when the short-range wireless signal strength is above a predetermined threshold, the hand-off message for causing a wide-area cellular network to hand off an existing cellular call at the wireless communication device to the VOIP service.

7. The system of claim 1, wherein the short-range wireless interface is selected from a group consisting of a Wi-Fi interface and a Bluetooth interface.

8. A wireless communication device, comprising:
a wide-area cellular network interface;
a short-range wireless interface;
a user interface configured to select either the short-range wireless interface or the wide-area cellular network interface to place and receive calls; and
a client configured to place and receive voice over Internet Protocol (VOIP) calls through the short-range wireless interface.

9. The wireless communication device of claim 7, wherein the client is configured to communicate with a proxy server running on a gateway, by way of the short-range wireless interface.

10. The wireless communication device of claim 8, wherein the proxy server passes the VOIP calls to and from a VOIP service client residing on the gateway.

11. The wireless communication device of claim 9, wherein the VOIP service client is configured to communicate with a VOIP service by way the Internet.

12. The wireless communication device of claim 7, wherein the user interface is configured to receive a called party number from a user and the client on the wireless communication device is configured to transfer the called party number to a proxy server residing on a gateway.

13. The wireless communication device of claim 7, wherein the short-range wireless interface is selected from a group consisting of a Wi-Fi interface and a Bluetooth interface.

14. The wireless communication device of claim 7, further comprising:
means for detecting a short-range wireless signal strength; and
means for transmitting a hand-off message to the VOIP service when the short-range wireless signal strength is above a predetermined threshold, the hand-off message for causing a wide-area cellular network to hand off an existing cellular call at the wireless communication device to the VOIP service.

15. A method of providing voice over Internet Protocol (VOIP) to a wireless communication device, comprising:
placing a call at the wireless communication device;
transmitting the call through a short-range wireless interface from the wireless communication device to a gateway;
establishing a VOIP call session using a proxy server residing at the gateway; and
the proxy server routing the call through a VOIP service client residing at the gateway.

16. The method of claim 15, further comprising:
receiving a called party number from a user at the wireless communication device; and
transferring the called party number to the proxy server by way of the short-range wireless interface.

17. The method of claim 15, further comprising:
detecting a short-range wireless signal strength; and
transmitting a hand-off message to a VOIP service when the short-range wireless signal strength is above a predetermined threshold, the hand-off message for causing a wide-area cellular network to hand off an existing cellular call at the wireless communication device to the VOIP service.

18. The method of claim 15, wherein the short-range wireless interface is selected from a group consisting of a Wi-Fi interface and a Bluetooth interface.

19. The method of claim 15, wherein the VOIP service client is configured to communicate with a VOIP service by way of the Internet.

20. The method of claim 15, further comprising:
selecting, at the wireless communication device, either the short-range wireless interface or a wide-area cellular network interface to place and receive calls.
